(19) United States
(12) Patent Application Publication
(10) Pub. No.: US 2005/0182682 A1
(43) Pub. Date: Aug. 18, 2005

(54) Point of sale system

(76) Inventor: Gordon Michael Wiram, Cave Creek, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(21) Appl. No.: 09/777,722

(22) Filed: Feb. 5, 2001

(51) Int. Cl. G06F 17/60

(52) U.S. Cl. 705/16

(57) ABSTRACT

A comprehensive point of sale system for use in the field of moving equipment rental is disclosed. The point of sale system preferably includes a rental feature, a return feature, a reservation feature, a transfer feature, a reversal feature and a reporting feature. By using the point of sale system, the dealer is able to reserve and rent quipment, sell support items, process the return of equipment and transfer equipment from one location to another. The system enables the customer to pay in cash, check, credit card, corporate charge account or a promissory note. If payment is made by credit card, the system includes an integral credit card authorization feature that processes the charge, obtains charge authorization and prints out a charge receipt. The reporting feature of the system provides the dealer with various reports pertaining to the activities of the business.

### FIELD OF THE INVENTION

The present invention relates generally to a point of sale system and particularly to a point of sale system that facilitates the completion of a transaction in the field of equipment rental.

### BACKGROUND OF THE INVENTION

The moving rental equipment business requires a dealer to track the equipment in the dealer's inventory, the reservations made for the equipment and any deposits or other payments made by a customer. To facilitate the equipment rental business, it is desirable to provide a comprehensive system that allows the dealer to track inventory and reservations and to process rental transactions.

If there are a large number of dealers, it is time-consuming and expensive to install specialized equipment at each dealer facility. Accordingly, it is desirable to provide a system that requires minimal equipment and does not require installation.

### SUMMARY OF THE PREFERRED EMBODIMENTS

A comprehensive point of sale system for use in the field of moving equipment rental is disclosed. The point of sale system preferably includes a rental feature, a return feature, a reservation feature, a transfer feature, a reversal feature and a reporting feature. By using the point of sale system, the dealer is able to reserve and rent equipment, sell support items, process the return of equipment and transfer equipment from one location to another. The system enables the customer to pay in cash, check, credit card, corporate charge account or a promissory note. If payment is made by credit card, the system includes an integral credit card authorization feature that processes the charge, obtains charge authorization and prints out a charge receipt. The reporting feature of the system provides the dealer with various reports pertaining to the activities of the business.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a preferred embodiment of the login feature of the point of sale system of the present invention;

FIG. 2 is a preferred embodiment of the main page of the point of sale system of the present invention;

FIG. 3 is a preferred embodiment of the rental option window of the present invention;

FIG. 4 is a preferred embodiment of the reference entry section of the present invention;

FIG. 5 is a preferred embodiment of the customer information section of the present invention;

FIG. 6 is a preferred embodiment of the license information section of the present invention;

FIG. 7 is a preferred embodiment of the meaningful assurance section of the present invention;

FIG. 8 is a preferred embodiment of the return date and time section of the present invention;

FIG. 9 is a preferred embodiment of the select truck section of the present invention;

FIG. 10 is a preferred embodiment of the rate information feature of the present invention;

FIG. 11 is a preferred embodiment of the support sales section of the present invention;

FIG. 12 is a preferred embodiment of the schedule of charges of the present invention;

FIG. 13 is a preferred embodiment of the credit card authorization feature of the present invention;

FIG. 14 is a preferred embodiment of the finish function of the present invention;

FIG. 15 is a preferred embodiment of a contract that is provided by the point of sale system of the present invention;

FIG. 16 is a preferred embodiment of the contract information section of the present invention;

FIG. 17 is a preferred embodiment of the truck information section of the present invention;

FIG. 18 is a preferred embodiment of the contract on- hold feature of the present invention;

FIG. 19 is a preferred embodiment of the reimbursement feature of the present invention;

FIG. 20 is a preferred embodiment of cash transaction feature of the present invention;

FIG. 21 is a preferred embodiment of the corporate move account feature of the present invention;

FIG. 22 is a preferred embodiment promissory note feature of the present invention;

FIG. 23 is a preferred embodiment of the transfer function window of the present invention;

FIG. 24 is a preferred embodiment of the contract information section of the present invention;

FIG. 25 is a preferred embodiment of the equipment information section of the present invention;

FIG. 26 is a preferred embodiment of the remarks section of the present invention;

FIG. 27 is a preferred embodiment of a receipt of the present invention;

FIG. 28 is preferred embodiment of a reservation options window of the present invention;

FIG. 29 is a preferred embodiment of the date reservation information section of the present invention;

FIG. 30 is a preferred embodiment of the truck information section of the present invention;

FIG. 31 is a preferred embodiment of the support rental items section of the present invention;

FIG. 32 is a preferred embodiment of a marketing section of the present invention;

FIG. 33 is a preferred embodiment of a reporting options section of the present invention;

FIG. 34 is a preferred embodiment of an inventory report of the present invention; and

FIG. 35 is a preferred embodiment of an equipment due in report of the present invention.

Like numerals refer to like parts throughout the several views of the drawings.

### DETAILED DESCRIPTION OF THE PREFERRED EMBODIMENTS

In a preferred embodiment of the present invention, a point of sale system 10 is provided to enable a user to complete a sales transaction in the moving rental equipment field. The process of completing a sales transaction includes reserving rental equipment, renting and paying for the equipment, and executing the necessary agreements reflecting the terms of the sales transaction. The point of sale system of the present invention is preferably available to users on a network, and more preferably on the internet. The network has at least one computer-server for communicating with users. Communications with the users is preferably carried out using a browser based program on a computer terminal at a location remote from the computer-server. The point of sale system 10 preferably includes a processor and various databases, as known in the art, for storing and retrieving information pertaining to customers, reservations, equipment, inventory, rental transaction and other information, as described more fully hereinafter.

Point of sale system 10 is preferably password protected allowing access only to the authorized users of the system.

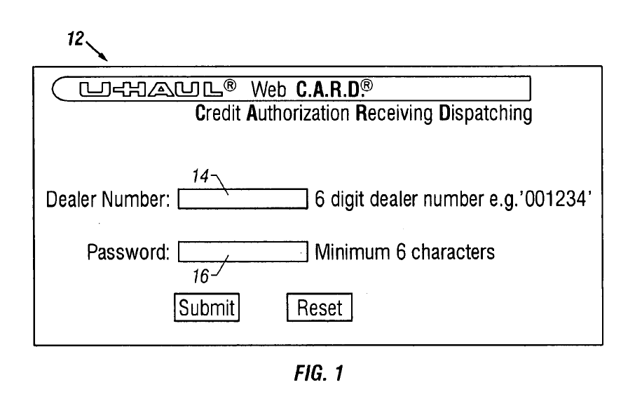

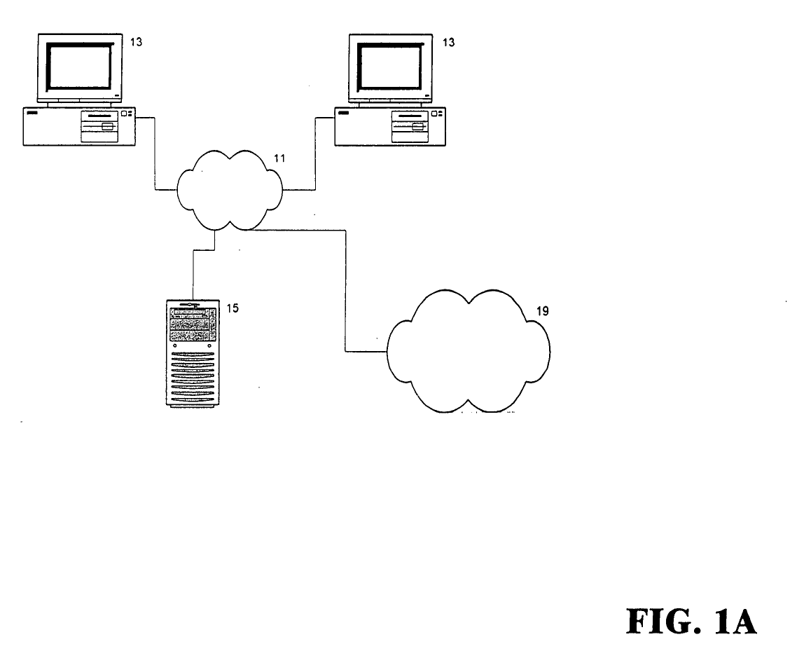

As shown in FIG. 1, the point of sale system 10 of the present invention is preferably accessible via a login feature 12. The login feature 12 prompts the user for a dealer number 14 and a password 16. Upon verification of a valid dealer number 14 and password 16, the user is granted access to the other features of the point of sale system.

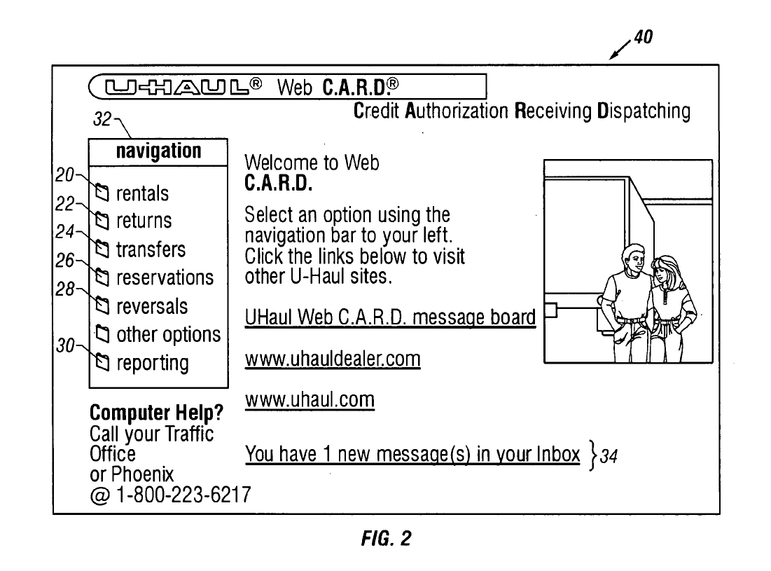

As best shown in FIG. 2, in a preferred embodiment of the present invention, the point of sale system 10 includes a rental feature 20, a return feature 22, a transfer feature 24, a reservation feature 26, a reversal feature 28, and a reporting feature 30. These features are preferably listed on a navigation menu 32 on the system's main page 40. The main page of the system 40 preferably is exhibited immediately after the user's dealer number 14 and password are verified. In a preferred embodiment, the main page 40 includes a message center 34 that notifies the user of any important messages. Messages that could be posted on the message center 34 include company-wide announcements and marketing information, such as the announcement of new products or services. Also, the message center 34 can be used to inform particular dealers that there is a message in an inbox (not shown) that can be accessed by the particular dealer. For example, a dealer may be informed of a new reservation or the transfer of new equipment to the dealer. In the embodiment shown in FIG. 2, the message center 34 includes a marketing message stating, “Selling U-Haul boxes is a great way to add extra income to your business, ask your AFM for details.” The message center 34 can also be used as a mechanism to poll the dealer's on a particular topic. For example, to determine the frequency of renting a particular type of truck, the message center 34 includes a question, such as “Have you rented any 14 foot moving vans today?” By responding to the question posed in the message center 34, it will be possible to determine the percentage of dealers that rent 14 foot moving vans on a particular day.

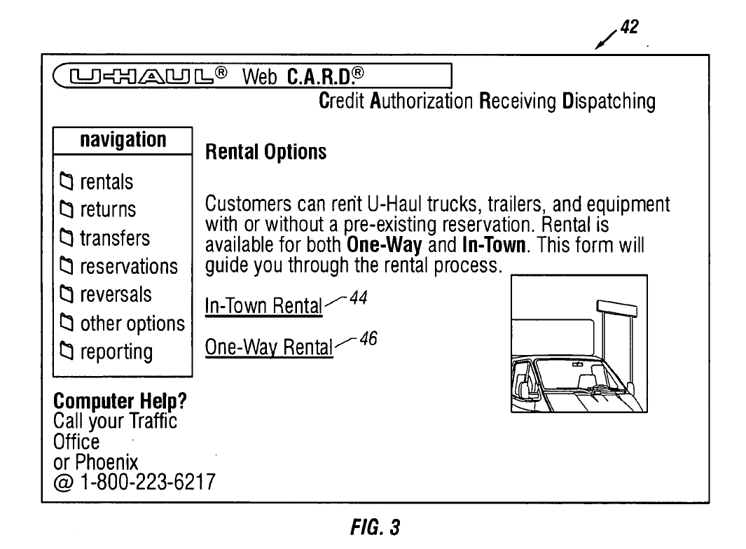

With reference to FIGS. 3 through 15, a preferred embodiment of the rental feature 20 of the present invention is described. The rental feature 20 is accessible by choosing the rental feature 20 from the navigation menu 32 on the main page 40 of the system. The rental feature 20 preferably allows the user to process rentals of trucks, trailers and other equipment with or without a pre-existing reservation. In a preferred embodiment of the invention, the user is guided through the rental feature 20 and prompted for the information that is necessary to complete the transaction. Thus, the user is able to complete the rental transaction easily and quickly.

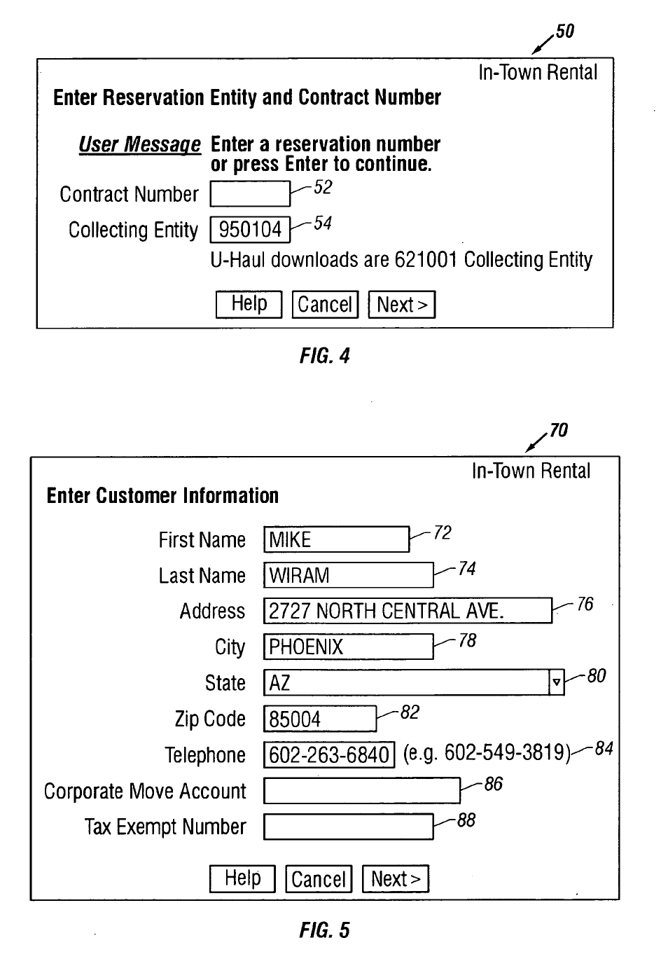

As shown in FIG. 3, a rental option window 42 provides the user with the options of in-town rental 44 and one-way rental 46. Depending on the location in which the customer desires to use the item, the user selects either the in-town rental 44 or one-way rental 46 to proceed. After selecting the appropriate category of rental, the rental feature 20 preferably directs the user to a reference entry section 50, shown in FIG. 4. In the reference entry section 50, the user enters a contract number 52 and a collecting entity number 54. If a previous reservation was made, a contract number has been assigned to the reservation. By entering the contract number 52 on the reference entry section 50, the system recalls the information pertaining to the reservation and displays the information. If there is no previous contract number 52 to enter on the reference entry section 50, the user can leave the contract number 52 blank. Upon detecting a blank entry as the contract number 52, the system automatically assigns a new contract number to the transaction. The collecting entity number 54 refers to the identification number of a particular user. The system confirms that a valid contract number 52 (or no number) and a valid collecting entity number 54 have been entered.

A help feature 60 is preferably available on the system to assist the user. For each type of transaction being performed, the help feature 60 is preferably customized to assist with each stage of that particular transaction. For example, the help feature 60, in the reference entry section 50, includes information pertaining to the valid contract numbers and collecting entity numbers. The customization of the help feature 60 allows the user to have relevant information at each stage of the transaction.

A preferred embodiment of the customer information section 70 of the present invention is shown in FIG. 5.

In the course of processing a rental transaction using the rental feature 20 of the invention, the system 10 prompts the user for information regarding the customer. The system enables the user to enter the customer's information directly into the customer information section 70 wherein it will be stored and retrieved as necessary. The customer information section 70 preferably prompts for the user's first and last name 72, 74, address 76, city 78, state 80, zip code 82, and telephone number 84. If the customer has a corporate account to cover moving expenses, the information can be entered in the corporate move account section 86 of the customer information section 70. By entering a corporate move account, all expenditures are charged to the corporate move account. The customer information section 70 also includes a section to enter the tax exempt number 88. If a valid tax exempt number is entered, the customer will not be charged any tax for the rental transaction.

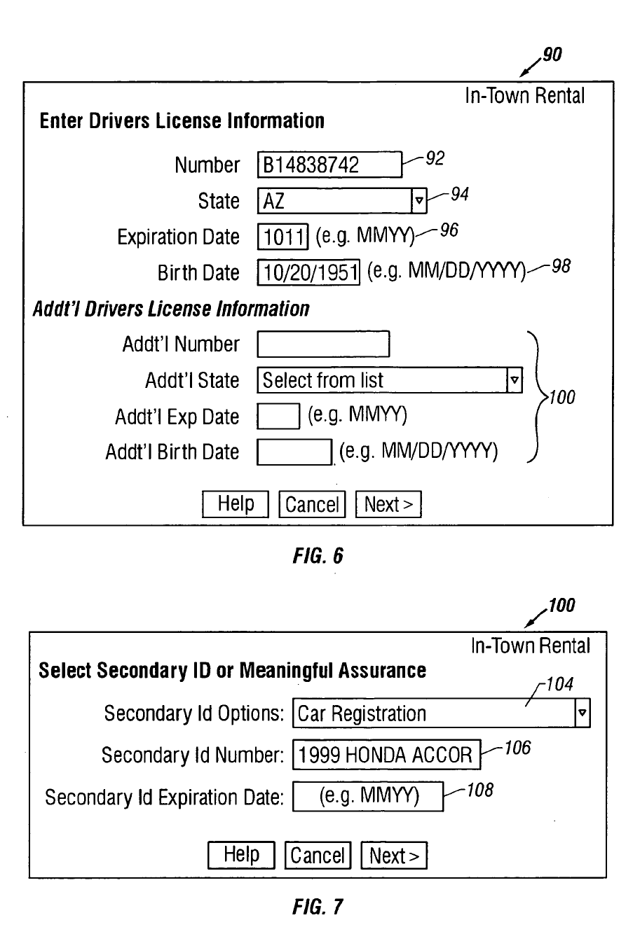

To ensure that the person renting a vehicle is licensed to drive the vehicle, in the course of the rental transaction, the system will prompt the user for the customer's driver license information. A preferred embodiment of the driver's license information section 90 of the present invention is shown in FIG. 6. The system enables the user to enter the customer's driver's license information directly into the driver's license information section 90 wherein it will be stored and retrieved as necessary. The driver's license information preferably prompts for the license number 92, the license issuing state 94, the expiration date 96 of the license, and the driver's birth date 98. If the driver has an additional license, the information for the supplemental license can be entered in the supplemental license section 100.

Typically, moving vans, trailers and other rental equipment are expensive and the deposit that is required to be paid by the customer does not nearly cover the value of the equipment. Accordingly, it is desirable for dealers to collect additional information that would enable the dealer to find the customer if the equipment is not returned. Also, some dealers may require collateral if the customer does not have secondary identification. The point of sale system 10 of the present invention preferably includes a meaningful assurance section 102 that enables the dealer to enter secondary identification information or information pertaining to collateral used for the rental into the system. The meaningful assurance section 102 preferably prompts for the type of secondary identification or collateral 104, the secondary identification number or collateral description 106, and an expiration date 108, if any. In the embodiment shown in FIG. 7, the meaningful assurance that is provided by the customer is a car registration for a 1999 Honda Accord.

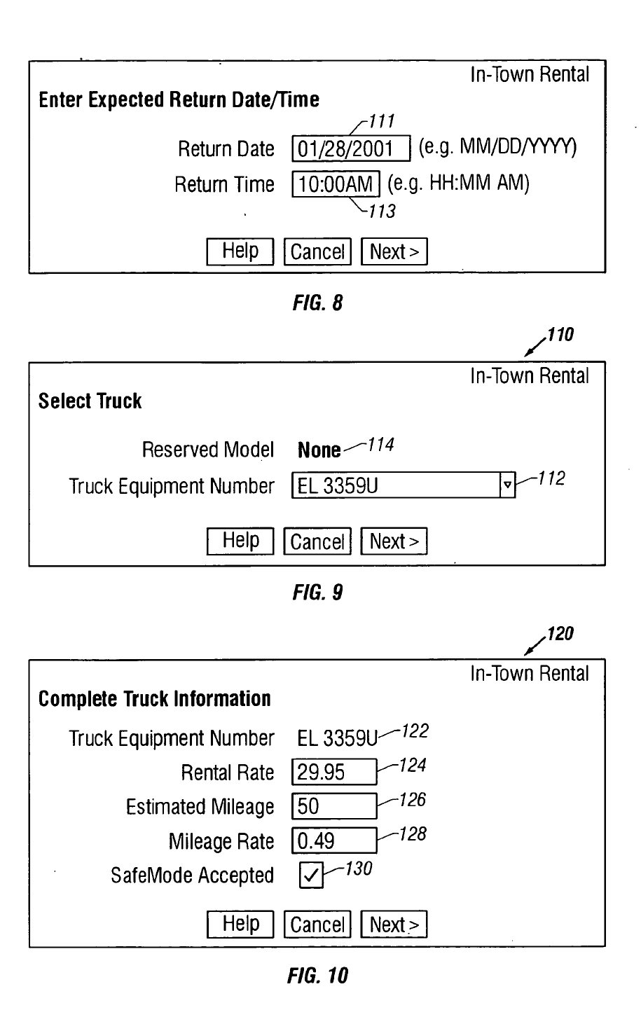

After the customer's information is gathered, the system prompts the user for information pertaining to the rental item and the date and time for which the rental item is needed. As shown in FIG. 8, the system prompts the user for an expected date of return 110 and an expected time of return 112. Upon entry of the return date 110 and return time 112, the system calculates the duration of the rental for the purpose of determining the rental fee.

Additionally, the system tracks the dates of rental for each piece of equipment and at any time can produce a report as to the equipment that is due in, as explained more fully below.

The system also prompts the user for information pertaining to the specific equipment that is the subject of the rental transaction. As shown in FIG. 9, the select truck section 110 of the system enables the user to input the truck equipment number 112 of the rental item that the customer is interested in renting. In a preferred embodiment of the invention, the truck equipment number 112 can be selected from a pull-down menu which lists the equipment numbers of all trucks that are available for ental at a particular location. Accordingly, the user can simply select an equipment number from the list. If a reservation was made prior to the rental transaction, the reserved model 114 would be displayed on the select truck section 110.

At this point in the rental transaction, the system has prompted for and received information regarding the dates of rental and the type of truck being rented. In a preferred embodiment of the invention, the system is programmed to store the rental rates for each type of equipment available. Thus, the system has sufficient information to calculate the amount that will be owed by the client for the rental transaction. FIG. 10 depicts a preferred embodiment of the rate information feature 120 of the present invention. In the rate information feature 120, the system 10 preferably automatically provides the user with rate information for the equipment selected.

In the embodiment shown in FIG. 10, the rate information feature 120 lists the truck equipment number 122, the rental rate 124 for the specified truck, the estimated mileage 126 that the truck will be driven, the mileage rate 128 for the truck and whether a liability waiver contract has been accepted 130. The truck equipment number 122, rental rate 124, estimated mileage 126, mileage rate 128 and waiver contract 130 are automatically populated with information provided by the system. In a preferred embodiment, the system is programmed to provide this information in response to the parameters entered. For example, for the type of truck specified in the truck equipment number 122, the system 10 returns a rental rate 124 of $29.95. For an in-town rental, the system 10 estimates a use mileage 126. In the embodiment shown in FIG. 10, the estimated mileage 126 is 50 miles. The system 10 also provides the mileage rate 128, which is $ 0.49 per mile for the embodiment shown in FIG. 10.

The system 10 preferably enables the user to modify the rental rate 124, estimated mileage 126, and mileage rate 128 figures that are automatically provided by the system. Thus, if a dealer is having a special promotion wherein the dealer is offering a truck for less than the amount programmed in the system 10, the dealer has the option to manually enter a different amount in the rental rate 124. Similarly, if it is estimated that the truck will be driven less than the estimated mileage 126 specified by the system 10, the dealer has the option to manually enter a different number of miles in the estimated mileage 126.

Additional trucks and trailers can be added to the same transaction in the same manner. Namely, the system 10 preferably prompts the user to provide the equipment number for additional trucks or trailers that the customer wishes to rent. If the customer is interested in renting an item that does not include a serial number, such as an appliance dolly or other support item, then the quantity of the item is recorded. As described above, the point of sale system 10 preferably automatically provides the estimated charges associated with the rental of the items selected.

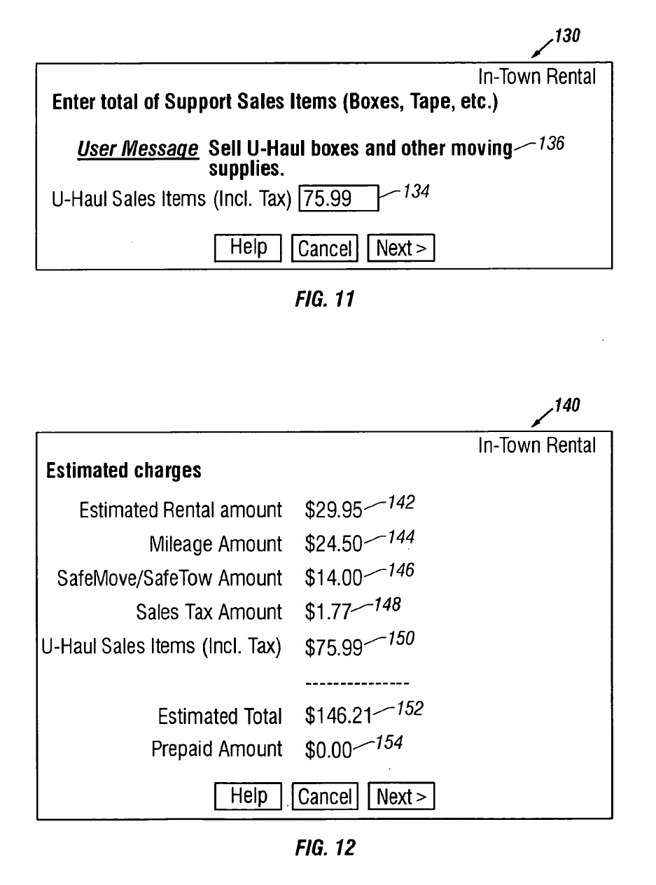

In addition to the moving trucks, trailers and other moving equipment, the customer may also purchase, in the same transaction, support sales items such as boxes, tapes or other similar supplies. As shown in FIG. 11, the point of sale system 10 of the present invention includes a support sales section 132. The support sales section 132 enables the user to enter the total amount due 134 for the sale of support sales items such as boxes, tapes or other moving supplies. By entering the total amount due 134 for the sale of support sales items, the user will create a comprehensive record of the transaction because the sale of the support items will be listed on the customer's receipt and the customer will be able to pay for the items at the same time as paying the rental fees.

The system 10 may also include a marketing message 136, an example of which is shown in FIG. 11. The marketing message 136 could include a reminder to the dealers to check whether the customer will need any support items such as boxes, blankets, furniture pads, dollies, etc. The purpose of the marketing message is to alert the dealer and cause the dealer to inquire as to the customer's needs and ensure that the customer has the equipment and supplies needed for a successful move.

After the customer has selected the items that will be needed, the point of sale system 10 preferably provides the customer with a schedule of charges 140. An example of a preferred embodiment of the schedule 140 is shown in FIG. 12. The schedule of charges 140 preferably includes the rental amount 142, the mileage amount 144, the liability waiver amount 146, the sales tax amount 148, and the sales items total 150. The total sum 152 is displayed. If there has been a prepayment 154, that amount is also displayed.

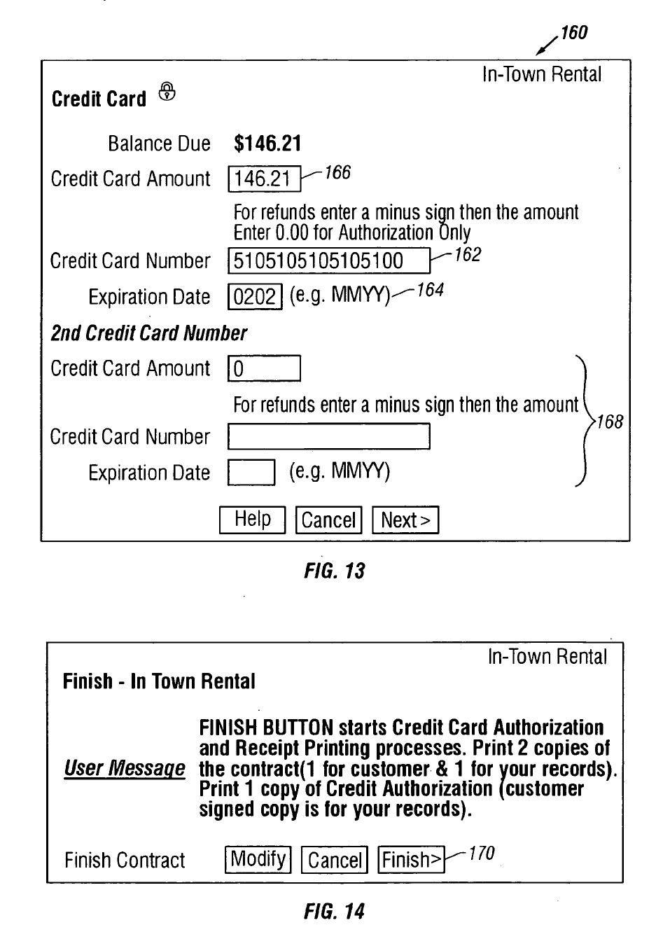

To pay the amount due, the point of sale system 10 includes a credit card authorization feature 160, as shown in FIG. 13. One of the advantages of having a point of sale system that combines the reservation and rental features with the credit authorization feature 160 is that there is no need for a separate telephone line or receipt printing machine to complete a credit card transaction. In a preferred embodiment of the invention, the credit card approval is obtained via the internet, eliminating the need for a time-consuming credit card procedure that utilizes a telephone line.

The credit card authorization feature 160 enables the user to enter the customer's credit card number 162, expiration 164 and amount to be charged on the credit card 166. In a more preferred embodiment of the invention, an electronic card reader is connected to the point of sale system 10 such that by swiping the credit card on the electronic card reader, the credit card information is automatically entered into the credit card number 162 and expiration 164 fields of the credit card authorization feature 160. If more than one credit card is used to remit payment, information pertaining to the second credit card is entered in the supplemental credit card section 168 of the credit card authorization feature.

At any point during the rental transaction, the point of sale system 10 allows the user to review and amend previous entries. If there has been a mistake or if the customer has changed his or her mind regarding a service or product, the user can navigate through the different features and sections to correct the information previously inputted.

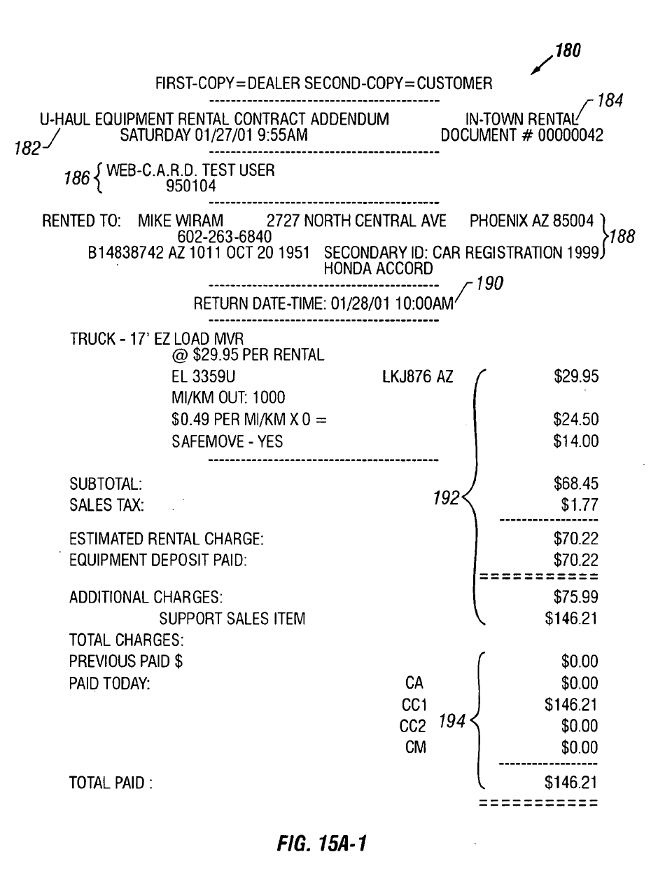

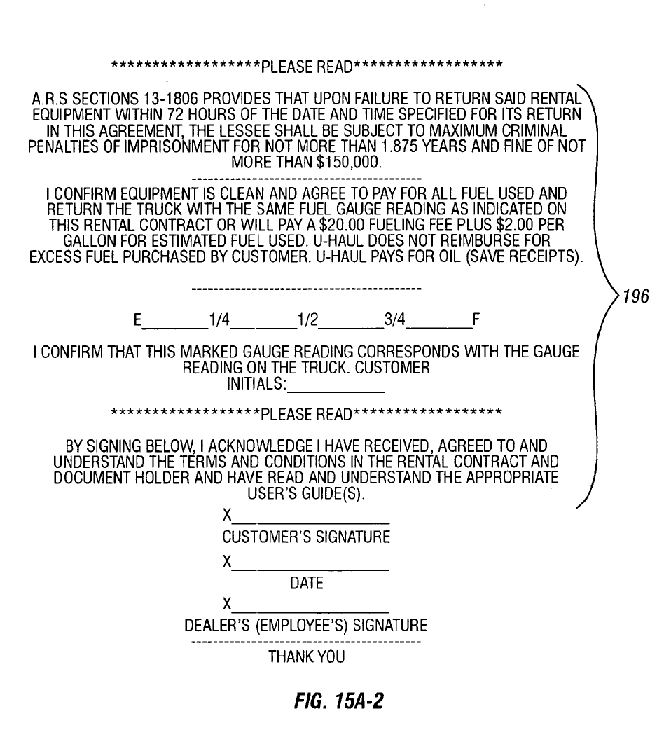

After the appropriate amendments have been made, the system provides the user with a mechanism to indicate that the terms, as inputted are final. As shown in FIG. 14, system 10 includes a finish function 170 that finalizes the transaction. By activating the finish function 170, the point of sale provides the user with a completed agreement to be executed by the customer. An example of the agreement is depicted in FIG. 15.

Upon activating the finish function 170, the system 10 automatically contacts the appropriate credit card agency and obtains authorization for the charge, at which point a receipt is printed for the customer's signature.

In a preferred embodiment, as shown in FIG. 15, the equipment rental contract 180 includes the date of the agreement 182, the contract number 184, the dealer information 186, the customer information 188, the return date and time 190, an itemized list of charges 192, payment information 194 and terms and conditions of the contract 196. Upon execution of the agreement, the rental transaction is complete. The customer may then take possession of the rental equipment for the duration of the rental period.

If it is necessary to reverse a rental transaction, the point of sale system 10 preferably includes a reversal feature 28 that enables the user to reverse the rental transaction and provide the customer with a credit charge or a refund of the amount paid for the rental. The reversal feature 28 is preferably accessible from the navigation menu 32 of the main page 40 of the system. Upon completion of a reversal transaction, the reversal feature 28 preferably provides a receipt that provides information pertaining to the reversal transaction and provides the amount which is credited to the customer.

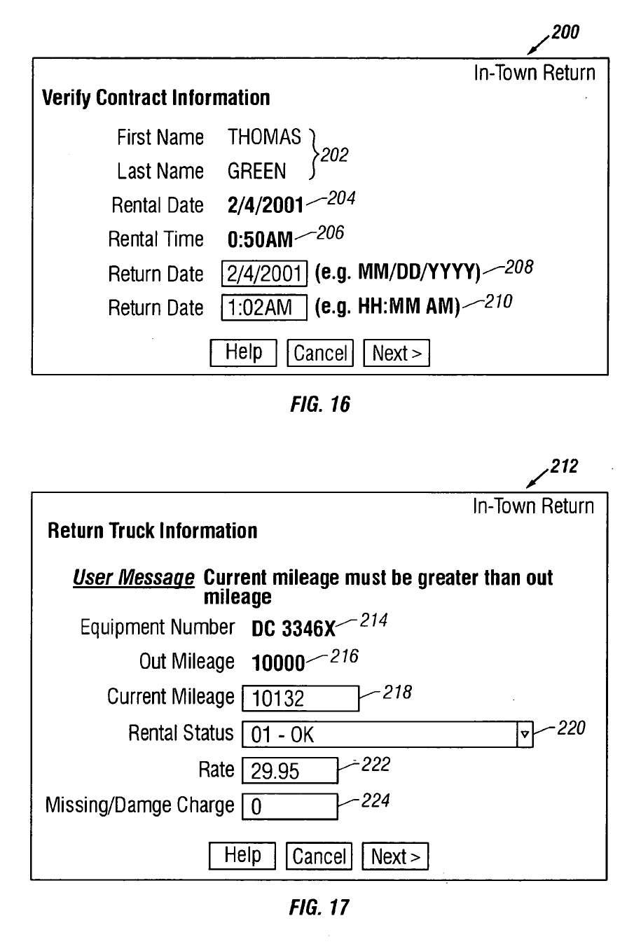

When a customer returns the rental equipment, the point of sale system 10 of the present invention preferably enables the user to process an equipment return transaction by using the return feature 22. In a preferred embodiment of the invention, the return feature 22 is accessible from the main page 40 of the system, shown in FIG. 2. After selecting the return feature 22, the user is preferably guided to the reference entry section 50, discussed above and shown in FIG. 4. The user enters the contract number 52 that has been assigned to the transaction. By entering the contract number 52, the system recalls the information pertaining to the transaction and displays the information. As shown in FIG. 16, the contract information section 200 is automatically populated by the system 10 with information pertaining to the reservation. In a preferred embodiment of the invention, the contract information section 200 displays the first and last name of the customer 202, the rental date 204 and time 206, and the return date 208 and time 210. The user can verify the information and amend the return date 208 and time 210, if necessary.

The return feature 22 includes a truck information section 212, as shown in FIG. 17, for entering the information pertaining to the rented vehicle upon return of the equipment. The information stored by the system 10 is automatically populated into the fields of the truck information section 212. In a preferred embodiment of the invention, the truck information section 212 automatically displays the equipment number 214 and the mileage of the vehicle 216 as of the date that the vehicle was rented. The truck information section 212 preferably prompts the user for the current mileage 218 of the vehicle, the status 220 of the vehicle, the daily rental rate 222 of the vehicle and any charges assessed for damage or missing equipment 224. The status 220 of the vehicle refers to the condition of the rental equipment and includes conditions such as, okay, damaged, inoperative, etc.

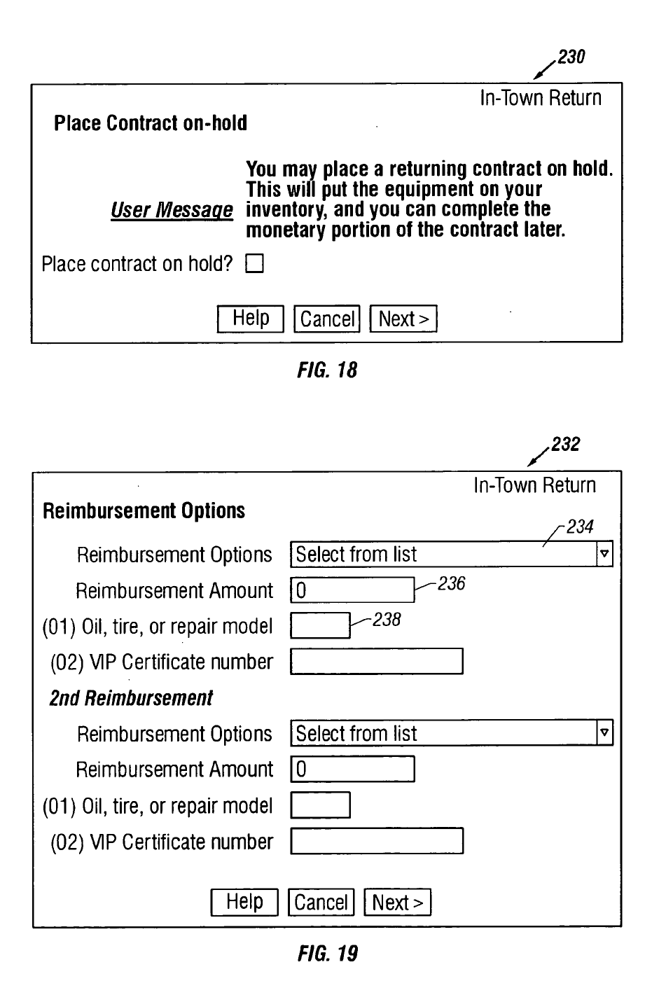

In a preferred embodiment of the invention, the point of sale system 10 includes a contract on-hold feature 230, shown in FIG. 18. The contract on-hold feature 230 enables the user to place a return transaction on hold. This feature will proceed with adding the equipment to the dealer's inventory, thus allowing rental of the equipment by other customers. However, the return transaction remains open and the user is given the option to complete the payment portion of the transaction at a later time. The contract on-hold feature 230 is useful when a customer leaves the equipment after hours and plans on returning at a later time to settle the rental charges. By activating the contract on-hold feature 230, the dealer is able to check the equipment in, and close the transaction when the customer returns.

If there were any expenditures for which the customer is entitled to reimbursement, the point of sale system 10 provides a mechanism by which the user can reimburse the customer for his or her expenditure. As shown in FIG. 19, the reimbursement feature 232 includes a reimbursement option 234, the reimbursement amount 236, and the type of expenditure 238 (such as oil, tire, repair, etc.). If the customer wishes to purchase additional supplies, or other sales items, the charges can be included in the return transaction. After all appropriate debits and credits have been entered, the point of sale system 10 preferably provides the user with an itemized schedule of charges 140, as shown in FIG. 12.

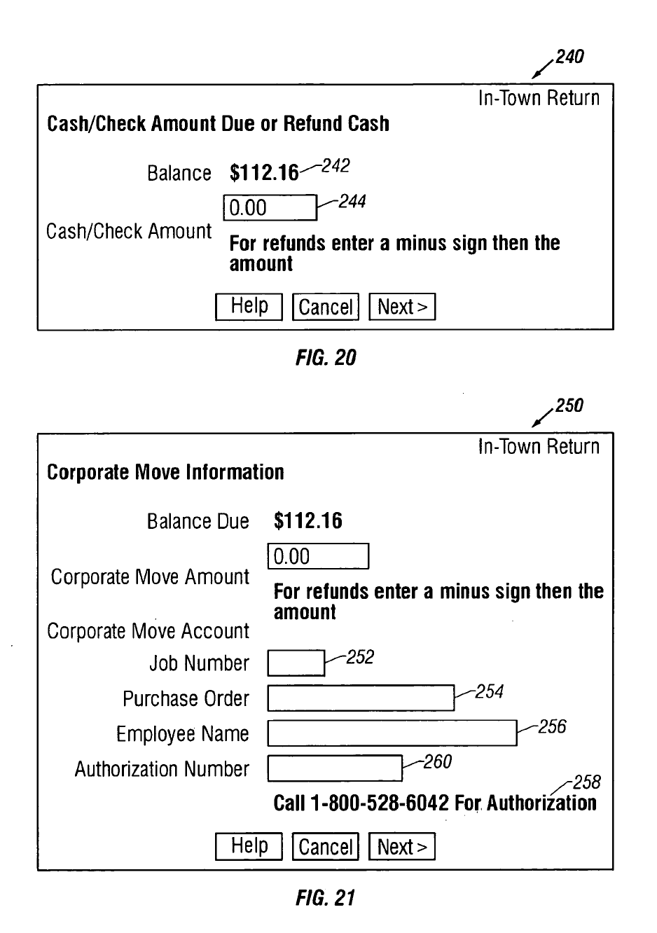

The customer may settle the charges by payment in cash, check, credit card, corporate move account, a promissory note or any combination thereof. Processing of the credit card was discussed above in connection with FIG. 13. FIG. 20, 21 and 22 depict the tools provided by the point of sale system 10 for recording payments by cash or check, corporate move account and promissory notes, respectively.

As shown in FIG. 20, the point of sale system 10 includes a cash transaction feature 240 that displays the amount due 242 and enables the user to enter the amount 244 being paid by cash or check. Upon entering the amount paid 244, the system subtracts the amount paid 244 from the amount due. If payment is made by charging a corporate move account, the corporate move account feature 250 of the point of sale system 10, as shown in FIG. 21, enables the user to record the corporate move account to be charged. The corporate move account information includes the job number 252, purchase order number 254, and employee name 256. The system 10 displays instructions 258 for obtaining authorization to charge a corporate move account and prompts the user for the authorization number 260, which must be entered before the transaction is allowed to proceed.

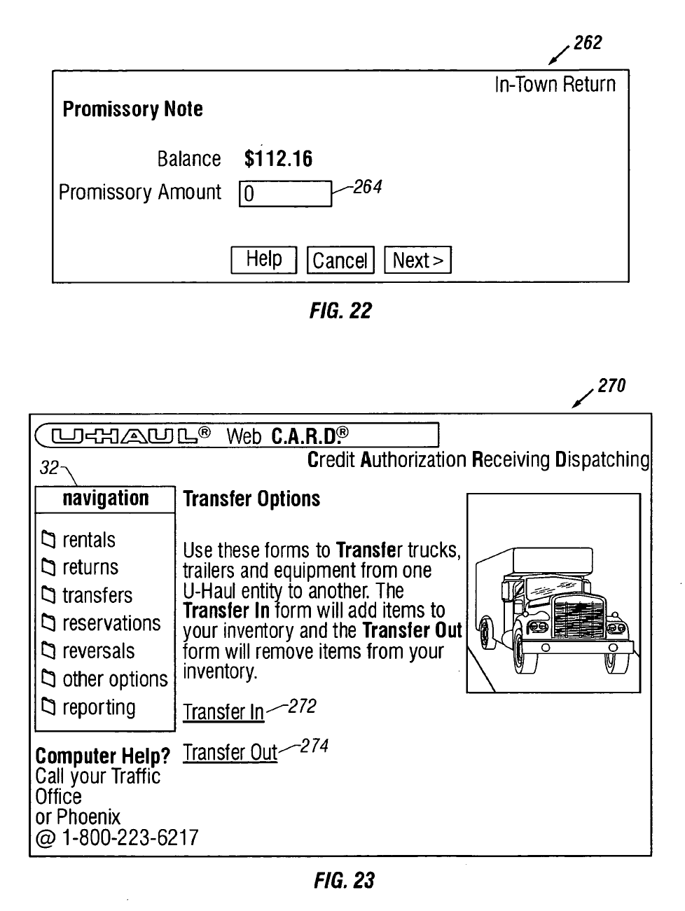

The customer may also sign a promissory note for the balance of the charges. As shown in FIG. 22, the point of sale system 10 includes a promissory note feature 262 that enables the user to record the amount 264 that is the subject of a promissory note. The terms and conditions of the note are preferably delineated in the contract that is printed at the end of each transaction.

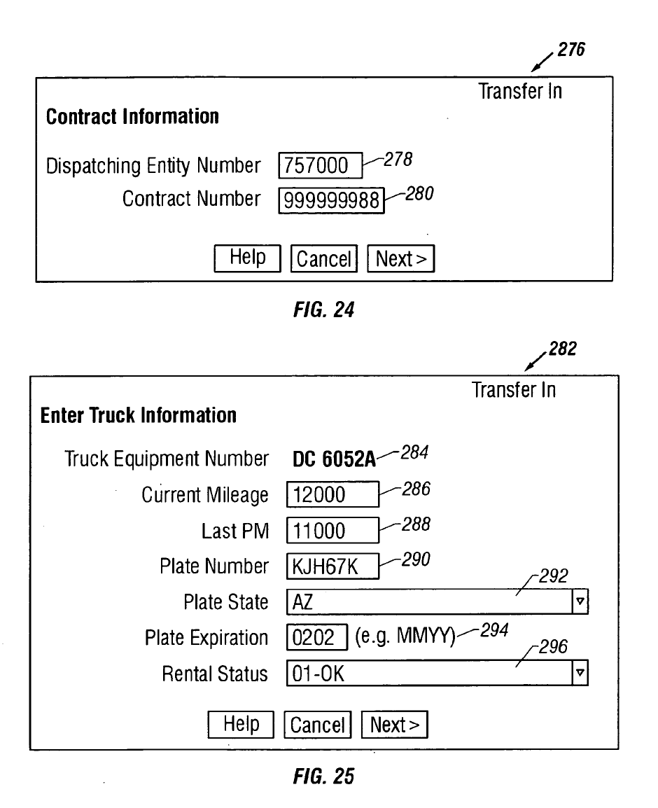

With reference to FIGS. 23 through 27, a preferred embodiment of the transfer feature 24 of the present invention is described. The transfer feature 24 is accessible by choosing the transfer feature 24 from the navigation menu 32 on the main page 40 of the system. The transfer feature preferably allows a user to transfer trucks, trailers and other equipment from one entity to another. As shown in FIG. 23, transfer option window 270 provides the user with the option of transferring the equipment in 272 or transferring the equipment out 274. After selecting the appropriate transfer category, the transfer feature 24 preferably directs the user to a contract information section 276, as shown in FIG. 24. In the contract information section 276, the user is prompted for a transfer entity number 278 and contract number 280. If the transaction is a transfer in transaction, the transfer entity number 278 refers to the dispatching entity. For a transfer out transaction, the transfer entity number 278 refers to the recipient entity. If no contract number 280 has been assigned to the transaction, the user can leave it blank. Upon detecting the blank, the system will automatically assign a contract number to the transfer transaction.

In a preferred embodiment of the present invention, as shown in FIG. 25, the transfer feature 24 includes an equipment information section 282 for providing information pertaining to the equipment being returned. To proceed with the transaction, the user preferably enters the truck equipment number 284, the current mileage 286 of the equipment, the last preventative maintenance 288 performed on the equipment, the license plate number 290, the license plate state 292, the plate expiration date 294 and the status of the equipment 296. If there are trailers or support rental items that are also being transferred, the information as to those equipment may also be entered into the point of sale system.

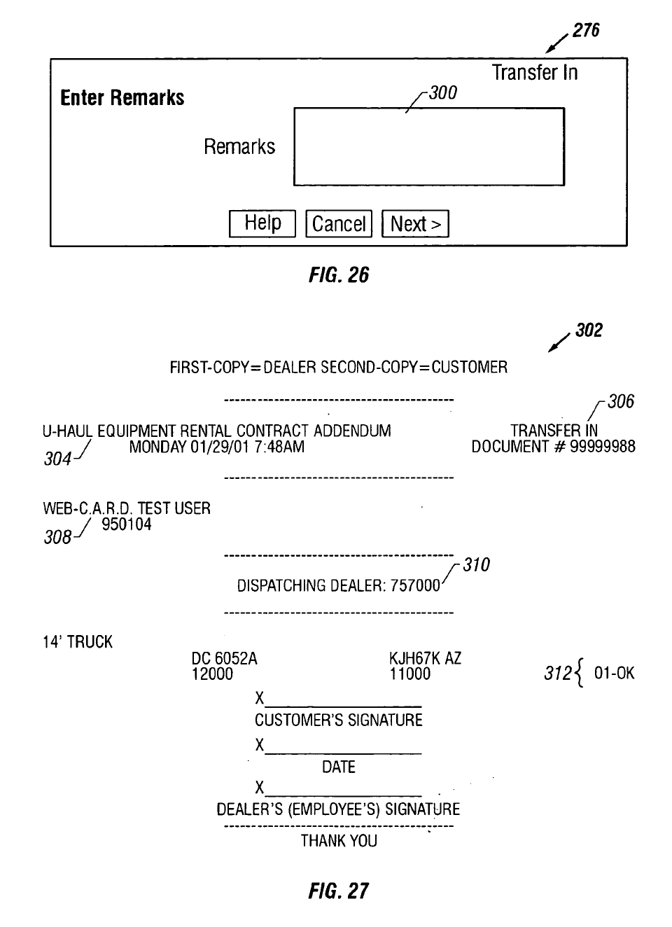

As shown in FIG. 26, the point of sale system 10 preferably includes a remarks section 300. A dealer can use the remarks section 300 to record notes about a particular piece of equipment that is being transferred or about the transfer process. The remarks section 300 is preferably also available and accessible through the other features of the system, including the rental feature 20, return feature 22, reservation feature 26, reversal feature 28 and reporting feature 30.

Upon completion of the transfer transaction, the point of sale system 10 preferably provides the user with a receipt 302, shown in FIG. 27. The receipt includes the date and time of the transaction 304, the document number 306, the receiving entity information 308, the dispatching entity information 310, and an itemized list 312 of the equipment being transferred. If the equipment is being transferred in, the equipment is then added to the dealer's inventory and made available for reservation and rental. If the equipment is being transferred out, the equipment is removed from the inventory.

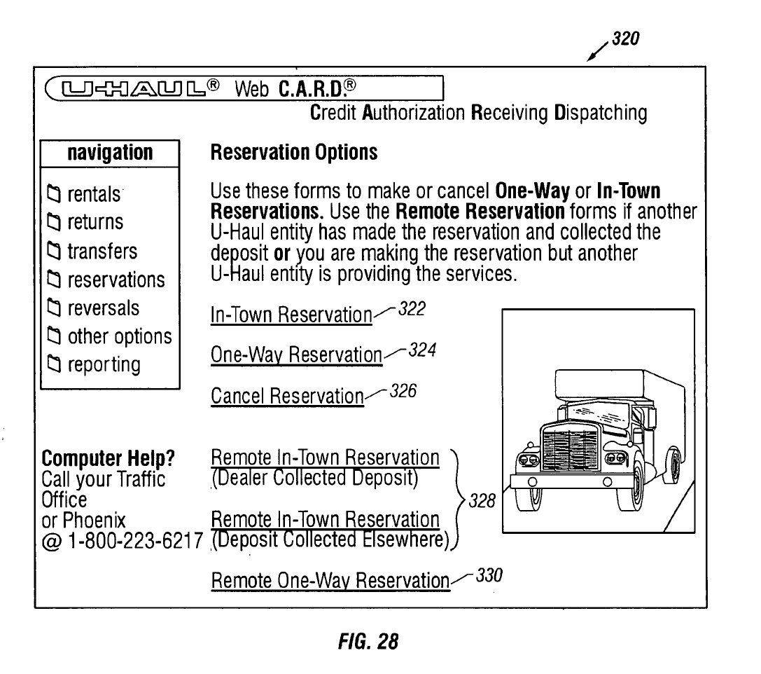

With reference to FIGS. 28 through 32, a preferred embodiment of the reservation feature 26 of the present invention is described. The reservation feature 26 is accessible by choosing the reservation feature 26 from the navigation menu 32 on the main page 40 of the system. The reservation feature 26 preferably allows the user to process reservations for trucks, trailers and other support rental items. As shown in FIG. 28, the reservation option window 320 provides the user with the options of in-town reservations 322, one-way reservations 324, cancel reservation 326, remote in-town reservation 328, and remote one-way reservation 330. The remote reservations 328, 330 are used in the event that another dealer has made the reservation and collected the deposit or if the user is making the reservation but another dealer is providing the services. To facilitate the taking of a reservation, the point of sale system 10 preferably includes a customer information section 70, as shown in FIG. 5. The customer information section 70 allows the user to enter information regarding the customer such as the customer's name, address, telephone number, and other identifying information. In a preferred embodiment of the invention, the system 10 also includes a driver's license information section 90 and a meaningful assurance section 102. The driver's license information section 90, as shown in FIG. 6 and discussed above, enables the user to enter the driver's license information for the customer. The meaningful assurance section 102, as shown in FIG. 7 and discussed above, enables the user to enter secondary identification information or information pertaining to collateral used for the rental into the system.

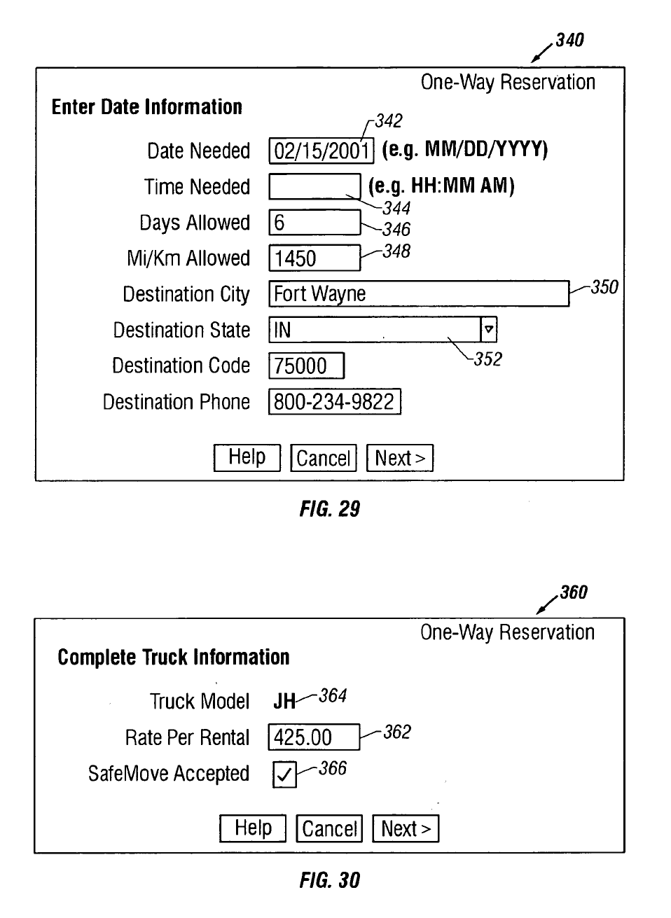

As shown in FIG. 29, the system preferably includes a reservation date information section 340 for inputting the customer's choice of rental dates. The reservation date information section 340 preferably includes the date 342 for which the equipment is needed, the time 344 for which it is needed, the days remaining 346 until the date 342 that the equipment is needed, the mileage 348 that is allowed for the equipment, and the destination city 350 and state 352 of the equipment (applicable for one-way rentals).

Upon specifying the type of equipment that the customer wishes to rent, the point of sale system 10 provides the user with the rental rate of the equipment. For example, in the truck information section 360, the rate per rental 362 of the equipment specified 364 is displayed. If the customer wishes to purchase a liability waiver, a waiver checkbox 366 is provided to indicate that the liability waiver is purchased.

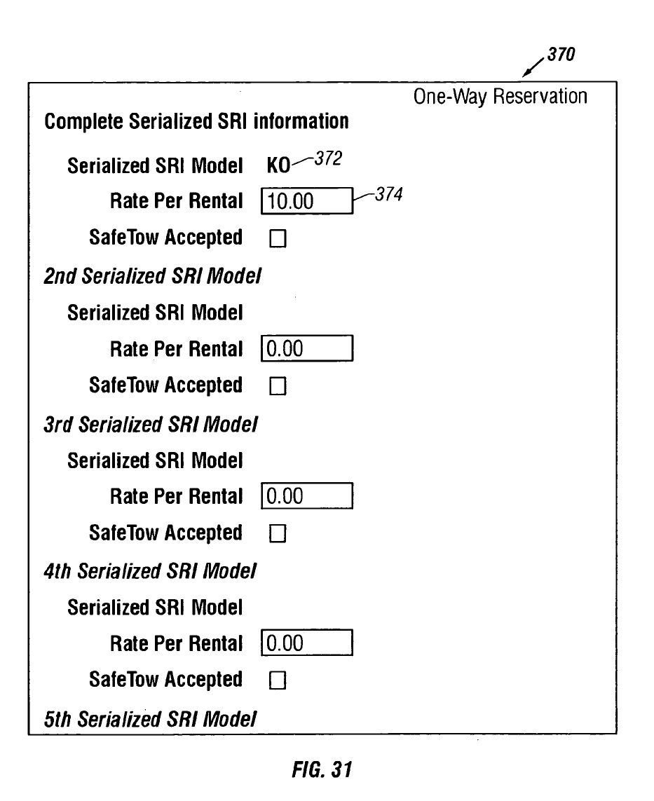

The reservation feature 26 includes a support rental item section 370, as shown in FIG. 31. The support rental item section 370 allows the user to specify the type of equipment 372 that the customer wishes to rent and the rate per rental 374 of the equipment.

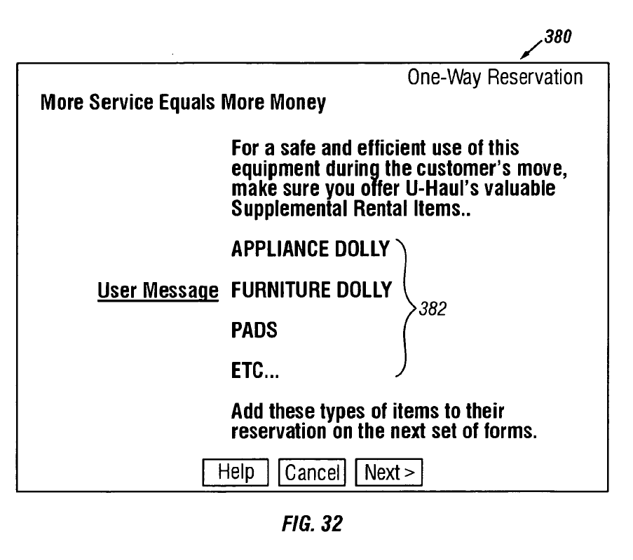

As shown in FIG. 32, in a preferred embodiment of the invention, the reservation feature 26 includes a marketing section 380 wherein the dealer is reminded to ensure that the customer has the supplies needed for a safe and efficient use of the equipment that is being rented. The marketing section 380 preferably lists the items 382 recommended to be used in conjunction with the equipment.

Upon selecting the items that the customer wishes to rent, the system 10 provides an itemized schedule of charges 140, as shown in FIG. 12 and discussed above. The point of sale system 10 enables to user to make a reservation deposit in check, cash, credit card charge, or corporate move account charge. The manner in which the charges are processed is discussed above. After completion of the reservation, the system 10 preferably provides the customer with a contract 180, as shown in FIG. 15 and discussed above.

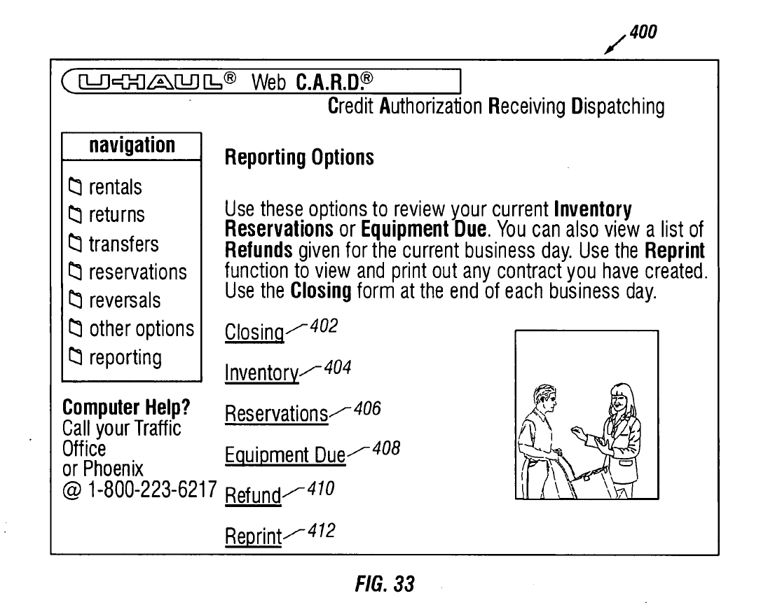

In a preferred embodiment of the invention, the point of sale system 10 generates various reports to inform the user of the status of reservations, equipment, sales and other information regarding the business of renting moving equipment. The reporting feature 30 is accessible by choosing the reporting feature 26 from the navigation menu 32 on the main page 40 of the system. As shown in FIG. 33, the reporting options window 400 provides the user with the options of a closing report 402, an inventory report 404, a reservation report 406, an equipment due report 408, and a refund report 410.

The closing report 402 preferably lists a summary of all transactions processed for a specified day. The report preferably includes dealer information and transaction information such as the contract number, the contract type, the method of payment, the amount received, the amount refunded and the total amounts received and refunded for all transactions. The closing report preferably calculates the net sum received in the transaction and calculates the net that is due to the dealer's distributor.

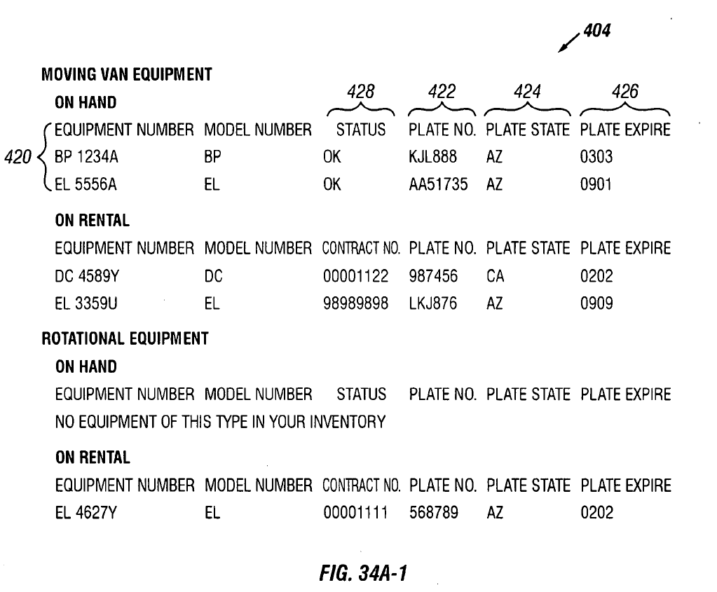

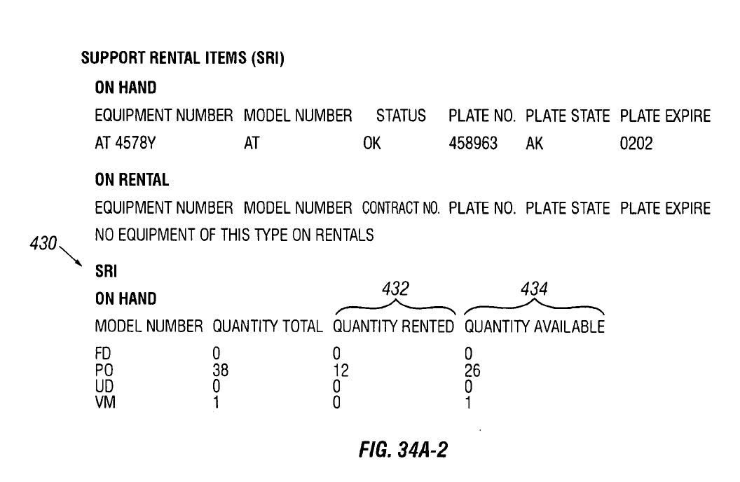

The inventory report 404, as shown in FIG. 34, preferably provides a list of rental inventory at the dealer site. In a preferred embodiment, the inventory report includes the number of moving vans, trailers and support rental items that are present at a dealer site. Information provided for each equipment include the equipment serial number 420, license-plate number 422, state or province in which the equipment is licensed 424, expiration date of license 426, current mileage indicated on the odometer (not shown) , and the status of the equipment 428. For non-serialized support rental equipment 430, the inventory report 404 preferably includes the quantity available 434 and the quantity rented 432.

The reservation report (not shown) preferably provides a list of customers who have made a commitment to rent equipment from a dealer. The information provided by the reservation report preferably includes the report date and time, the dealer identifying information, the contract number for each reservation, the contract date and time, the type of rental the equipment which was rented, and the customer's identifying information. The type of rental includes a one-way or an in-town rental.

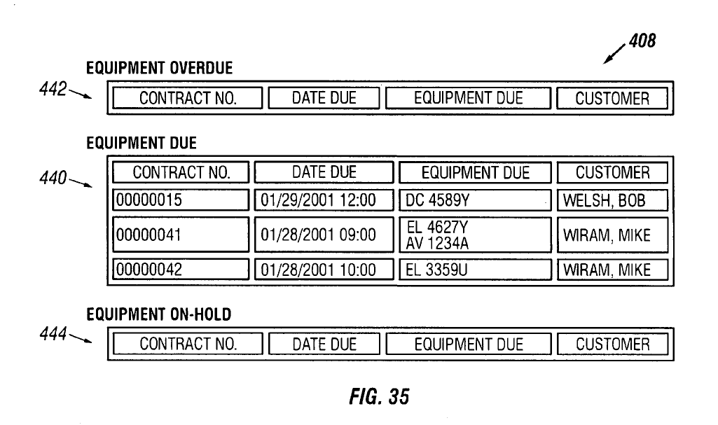

The equipment due report 408, as shown in FIG. 35, preferably lists equipment that is out on rental 440, equipment that is overdue 442 and contracts that have been on hold and not yet closed 444. The report 408 preferably identifies the equipment that is due 440 and the equipment that is overdue 442. For each item, the report preferably includes the type of equipment, the equipment number, the equipment due date and time, and the customer's name and telephone number. For each report, the date and time of the report, as well as the dealer's identification information is provided.

The refund report 410 preferably includes a list of refunds that have been provided to customers for a specified date. The reprint report 412 enables the user to reprint any contract that has already been completed.

The embodiments described above are exemplary embodiments of the point of sale system of the present invention. Those skilled in the art may now make numerous uses of, and departures from, the above-described embodiments without departing from the inventive concepts disclosed herein. For example, such departures could include alterations of the visual presentation of the graphical interfaces, the scope and extent of the information provided in each feature, and the organization of the functional features of the invention to provide accessibility to the features from various fields of the invention. Accordingly, the present invention is to be defined solely by the scope of the following claims.

1. A point of sale system comprising:
at least one computer having a computer readable medium with instructions stored thereon to provide a reservation feature having a customer information section and an equipment information section, wherein the customer information section and equipment information section display information pertaining to reservations; and
a payment section having a cash section, check section and a credit card section, wherein upon entering credit card information in the credit card section and activating the credit card section, credit authorization is obtained for a charge; wherein said system is operatively coupled to the internet.

2. A point of sale system comprising:
at least one computer having a computer readable medium with instructions stored thereon to provide a rental feature having a customer information section and an equipment information section, wherein the customer information section includes information pertaining to a customer, and the equipment information section includes information pertaining to the equipment that the customer is interested in renting; and
a payment section having a cash section, check section and a credit card section, wherein upon entering credit card information in the credit card section and activating the credit card section, credit authorization is obtained for a charge; wherein said system is operatively coupled to the internet.

3. The point of sale system of claim 2 further comprising a transfer feature having an equipment information section that prompts for information pertaining to equipment that is the subject of a transfer.

4. The point of sale system of claim 2 further comprising a return feature having an equipment information section that prompts for information pertaining to equipment that is being returned and a payment section for payment of a rental fee associated with the equipment returned.

5. The point of sale system of claim 2 further comprising a reporting feature that reports a status to a user.

6. The point of sale system of claim 5 further comprising a closing report having a list of all transaction processed for a specified day.

7. The point of sale system of claim 6 wherein the closing report includes a contract number, a method of payment, an amount received, and an amount refunded.

8. The point of sale system of claim 5 further comprising an inventory report having a list of the equipment available for rental.

9. The point of sale system of claim 5 further comprising a reservation report having a list of customers who have made a commitment to rent equipment.

10. The point of sale system of claim 5 further comprising an equipment due report having a list of equipment that is out on rental.

11. The point of sale system of claim 5 further comprising a refund report having a list of refunds that have been provided to a customer for a specified date.

12. The point of sale system of claim 11 further comprising a marketing section having a marketing message related to the moving equipment rental business.

13. A point of sale system comprising:
at least one computer having a computer readable medium with instructions stored thereon to provide a customer information section that stores and recalls customer information;
an equipment information section that stores and recalls information pertaining to a transaction; and
a rental feature that processes the rental transaction; wherein said system is operatively coupled to the internet.

14. The point of sale system of claim 13 wherein the rental feature displays a rental rate for an equipment identified equipment information section.

15. The point of sale system of claim 13 wherein the rental feature includes a printable rental agreement.

16. The point of sale system of claim 15 wherein the rental agreement includes the terms of the rental transaction.

17. The point of sale system of claim 15 wherein the rental agreement includes an itemized list of charges.

18. The point of sale system of claim 13 further comprising a credit card payment section which, upon activation, obtains credit card authorization.

19. A point of sale systemn comprising:
a computer network having at least one computer server for communicating with users and a computer readable medium with instructions stored thereon to provide a rental feature having a customer information section and an equipment information section, wherein the customer information section includes information pertaining to a customer, and the equipment information section includes information pertaining to the equipment that the customer is interested in renting; and
a payment section having a cash section, check section and a credit card section, wherein upon entering credit card information in the credit card section and activating the credit card section, credit authorization is obtained for the charge; wherein said point of sale system is operatively coupled to the internet.

20. The point of sale system of claim 19 further comprising a transfer feature having an equipment information section that prompts for information pertaining to equipment that is the subject of a transfer.

21. The point of sale system of claim 19 further comprising a return feature having an equipment information section that prompts for information pertaining to equipment that is being returned and a payment section for payment of a rental fee associated with the equipment returned.

22. The point of sale system of claim 19, further comprising a reporting feature that reports a status to a user.

23. The point of sale system of claim 22 further comprising a closing report having a list of all transaction processed for a specified day.

24. The point of sale system of claim 23 wherein the closing report includes a contract number, a method of payment, an amount received, and an amount refunded.

25. The point of sale system of claim 22 further comprising an inventory report having a list of the equipment available for rental.

26. The point of sale system of claim 22 further comprising a reservation report having a list of customers who have made a commitment to rent equipment.

27. The point of sale system of claim 22 further comprising an equipment due report having a list of equipment that is out on rental.

28. The point of sale system of claim 22 further comprising a refund report having a list of refunds that have been provided to a customer for a specified date.

29. The point of sale system of claim 28,further comprising a marketing section having a marketing message related to the moving equipment rental business.

30. A method of processing a point of sale transaction, comprising the steps of:
providing an internet-based browser system having a customer information section, an equipment information section and a payment processing section;
entering customer information into the customer information section;
entering into the equipment information section information pertaining to equipment that the customer is interested in renting;
entering payment information in the payment processing section, wherein the payment processing section includes a credit card authorization feature that, upon activation, contacts a credit authorization service, obtains authorization and prints out a receipt to be signed by the client.

31. A point of sale system, comprising:
a computer-server operatively coupled to the internet;
a computer readable medium having instructions stored thereon to provide a rental feature and a payment section, said rental feature having a customer information section and an equipment information section, wherein the customer information section includes information pertaining to a customer, and the equipment information section includes information pertaining to the equipment that the customer is interested in renting; and
said payment section having a cash section, check section and a credit card section, wherein upon entering credit card information in the credit card section and activating the credit card section, credit authorization is obtained for the charge.

32. The point of sale system of claim 31, wherein said computer server is configured to further include a transfer feature having an equipment information section that prompts for information pertaining to equipment that is the subject of a transfer.

33. The point of sale system of claim 31, wherein said computer server is configured to further include an equipment information section that prompts for information pertaining to equipment that is being returned and a payment section for payment of a rental fee associated with the equipment returned.

34. The point of sale system of claim 31, wherein said computer server is configured to further include a reporting feature that reports a status to a user.

35. The point of sale system of claim 34, wherein said reporting feature comprises a closing report having a list of all transaction processed for a specified day.

36. The point of sale system of claim 35 wherein the closing report includes a contract number, a method of payment, an amount received, and an amount refunded.

37. The point of sale system of claim 34 wherein said reporting feature comprises an inventory report having a list of the equipment available for rental.

38. The point of sale system of claim 34 wherein said reporting feature comprises a reservation report having a list of customers who have made a commitment to rent equipment.

39. The point of sale system of claim 34 wherein said reporting feature comprises an equipment due report having a list of equipment that is out on rental.

40. The point of sale system of claim 34 wherein said reporting feature comprises a refund report having a list of refunds that have been provided to a customer for a specified date.

41. The point of sale system of claim 31 wherein said computer server is configured to further include a marketing section having a marketing message related to the moving equipment rental business.

42. A point of sale system comprising:
an internet-based browser system;
a computer readable medium having instructions stored thereon to provide a rental feature and a payment section, said rental feature having a customer information section and an equipment information section, wherein the customer information section includes information pertaining to a customer, and the equipment information section includes information pertaining to the equipment that the customer is interested in renting; and
said payment section having a cash section, check section and a credit card section, wherein upon entering credit card information in the credit card section and activating the credit card section, credit authorization is obtained for the charge.

43. The point of sale system of claim 42, wherein said instructions further provide a transfer feature having an equipment information section that prompts for information pertaining to equipment that is the subject of a transfer.

44. The point of sale system of claim 42, wherein said instructions further provide a return feature having an equipment information section that prompts for information pertaining to equipment that is being returned and a payment section for payment of a rental fee associated with the equipment returned.

45. The point of sale system of claim 42, wherein said instructions further provide a reporting feature that reports a status to a user.

46. The point of sale system of claim 45, wherein said reporting feature comprises a closing report having a list of all transaction processed for a specified day.

47. The point of sale system of claim 46 wherein the closing report includes a contract number, a method of payment, an amount received, and an amount refunded.

48. The point of sale system of claim 45 wherein said reporting feature comprises an inventory report having a list of the equipment available for rental.

49. The point of sale system of claim 45 wherein said reporting feature comprises a reservation report having a list of customers who have made a commitment to rent equipment.

50. The point of sale system of claim 45 wherein said reporting feature comprises an equipment due report having a list of equipment that is out on rental.

51. The point of sale system of claim 45 wherein said reporting feature comprises a refund report having a list of refunds that have been provided to a customer for a specified date.

52. The point of sale system of claim 42, wherein said instructions further provide a marketing section having a marketing message related to the moving equipment rental business.
